(19) United States
(12) Patent Application Publication
(10) Pub. No.: US 2014/0229523 A1
(43) Pub. Date: Aug. 14, 2014

(54) CONTENT DELIVERY SYSTEM, CONTROL APPARATUS, AND CONTENT DELIVERY METHOD

(71) Applicant: Kazunori Ozawa, Tokyo (JP)

(72) Inventor: Kazunori Ozawa, Tokyo (JP)

(73) Assignee: NEC CORPORATION, Minato-ku, Tokyo (JP)

(21) Appl. No.: 14/343,693

(22) PCT Filed: Sep. 6, 2012
(86) PCT No.: PCT/JP2012/072770

§ 371 Date: Mar. 7, 2014

(30) Foreign Application Priority Data
Sep. 7, 2011 (JP) 2011-194562

(51) Int. Cl. H04L 29/08; H04L 12/947

(52) U.S. Cl. CPC H04L 67/2852; H04L 49/252
USPC 709/202

(57) ABSTRACT

A content delivery system includes: a packet forwarding apparatus(es) that forwards a plurality of contents delivered from a delivery server apparatus on the Internet; a plurality of cache servers that are arranged for or connected to the packet forwarding apparatus(es) and that temporarily store at least some of the plurality of contents; and a control apparatus that collects an access frequency of each of the at least some of the contents from the plurality of cache servers, arranges contents whose access frequency is equal to or higher than a predetermined threshold in the plurality of cache servers in accordance with a predetermined arrangement, and arranges the other contents in the plurality of cache servers in accordance with access frequencies of the other contents.

### REFERENCE TO RELATED APPLICATION

The present application is a National Stage Entry of PCT/JP2012/072770 filed Sep. 6, 2012, which is based on and claims the benefit of the priority of Japanese Patent Application No. 2011-194562, filed on Sep. 7, 2011, the disclosures of all of which are incorporated herein in their entirety by reference.

### FIELD

The present invention relates to a content delivery system, a control apparatus, and a content delivery method. In particular, it relates to: a content delivery system in which a content including a moving image, a still image, audio, software, an application, or the like is cached on a mobile network and the content is delivered to a terminal such as a mobile phone, a smartphone, a PC (personal computer), or a game machine; a control apparatus for the content delivery system; and a content delivery method.

### BACKGROUND

With increase in speed and capacity of mobile networks, content delivery is becoming increasingly common. In content delivery, contents are delivered to various terminals such as mobile terminals via mobile networks. It is predicted that the speed and capacity of mobile networks will be increased further through techniques such as LTE (Long Term Evolution) and EPC (Evolved Packet Core).

For example, PTL (Patent Literature) 1 discloses a technique relating to a content delivery system. According to PTL 1, the content delivery system is provided with cache apparatuses so as to reduce access time and to prevent network congestion.
PTL 1:
Japanese Patent Kokai Publication No. 2003-228534A

### SUMMARY

The entire disclosure of the above PTL is incorporated herein by reference thereto. The following analysis has been made by the present inventor.

It is predicted that the amount of data system traffic on mobile networks will be increased several dozen times by 2013 and that video contents will account for most of the data system traffic. In addition, as smartphones spread rapidly and terminal capabilities improve further, sizes of video contents are increasing more and more. Accordingly, it is predicted that hi-definition, large-capacity contents will also be delivered on mobile networks in the near future.

However, in a conventional content delivery system, when contents on the Internet are delivered via a mobile network, all the content requests from terminals are transmitted to a delivery server apparatus on the Internet via packet forwarding apparatuses. In addition, the delivery server apparatus delivers the contents to all the terminals via the packet forwarding apparatuses.

However, such configuration has the following problems.

When terminals access a popular content in a concentrated manner, traffic to the delivery server apparatus via the mobile network is concentrated. In addition, network load in an area where many accesses are made could surge locally. In such cases, until data reaches the delivery server apparatus, the data is congested in the mobile network. If such network congestion occurs, delay or packet loss is caused, deteriorating QoE (Quality of Experience) such as by freeze-up or deterioration of an image or interruption of voice on the terminal side. These problems can be more significant if more terminals are used and larger-capacity contents are delivered.

Furthermore, for example, when a new content is introduced and popularity of a certain content is suddenly changed, traffic becomes more concentrated. As a result, it will be difficult to avoid further concentration of the traffic to the delivery server apparatus and to avoid network congestion, counted as a problem.

Thus, there is a demand for a technique to avoid congestion on a mobile network even when contents are delivered via the mobile network and a certain content is accessed in a concentrated manner.

According to a first aspect of the present invention, there is provided a content delivery system comprising:

a packet forwarding apparatus(es) that forwards a plurality of contents delivered from a delivery server apparatus on the Internet;
a plurality of cache servers that are arranged for or connected to the packet forwarding apparatus(es) and that temporarily store at least some of the plurality of contents; and
a control apparatus that collects an access frequency of each of the at least some of the contents from the plurality of cache servers, arranges contents whose access frequency is equal to or higher than a predetermined threshold in the plurality of cache servers in accordance with a predetermined arrangement, and arranges the other contents in the plurality of cache servers in accordance with access frequencies of the other contents.

According to a second aspect of the present invention, there is provided a control apparatus, which is used in a content delivery system including a packet forwarding apparatus(es) that forwards a plurality of contents delivered from a delivery server apparatus on the Internet and a plurality of cache servers that are arranged for or connected to the packet forwarding apparatus(es) and that temporarily store at least some of the plurality of contents and which controls the plurality of cache servers;

wherein the control apparatus collects an access frequency of each of the at least some of the contents from the plurality of cache servers, arranges contents whose access frequency is equal to or higher than a predetermined threshold in the plurality of cache servers in accordance with a predetermined arrangement, and arranges the other contents in the plurality of cache servers in accordance with access frequencies of the other contents.

According to a third aspect of the present invention, there is provided a content delivery method, which is used in a content delivery system including a packet forwarding apparatus(es) that forwards a plurality of contents delivered from a delivery server apparatus on the Internet and a plurality of cache servers that are arranged for or connected to the packet forwarding apparatus(es) and that temporarily store at least some of the plurality of contents, the content delivery method comprising:

by a control apparatus controlling the plurality of cache servers, collecting an access frequency of each of the at least some of the contents from the plurality of cache servers;
arranging contents whose access frequency is equal to or higher than a predetermined threshold in the plurality of cache servers in accordance with a predetermined arrangement; and
arranging the other contents in the plurality of cache servers in accordance with access frequencies of the other contents.

The present invention provides the following advantage, but not restricted thereto. With the content delivery system, the control apparatus, and the content delivery method according the present invention, it is possible to avoid congestion on a mobile network even when contents are delivered via the mobile network and a certain content is accessed in a concentrated manner.

### BRIEF DESCRIPTION OF DRAWINGS

FIG. 1 illustrates a connection configuration of a content delivery system according to a first exemplary embodiment.

FIG. 2 is a block diagram illustrating a configuration of a control apparatus in the content delivery system according to the first exemplary embodiment.

FIG. 3 is a block diagram illustrating a configuration of a content arrangement calculation unit of the control apparatus in the content delivery system according to the first exemplary embodiment.

FIG. 4 is a block diagram illustrating a configuration of a cache server in the content delivery system according to the first exemplary embodiment.

FIG. 5 illustrates a connection configuration of a content delivery system according to a second exemplary embodiment.

### PREFERRED MODES

In the present disclosure, there are various possible modes, which include the following, but not restricted thereto. First, an outline of the present invention will be described. The reference characters in the following outline are merely used as examples to facilitate understanding of the present invention. Therefore, the reference characters are not intended to limit the present invention to the illustrated modes.

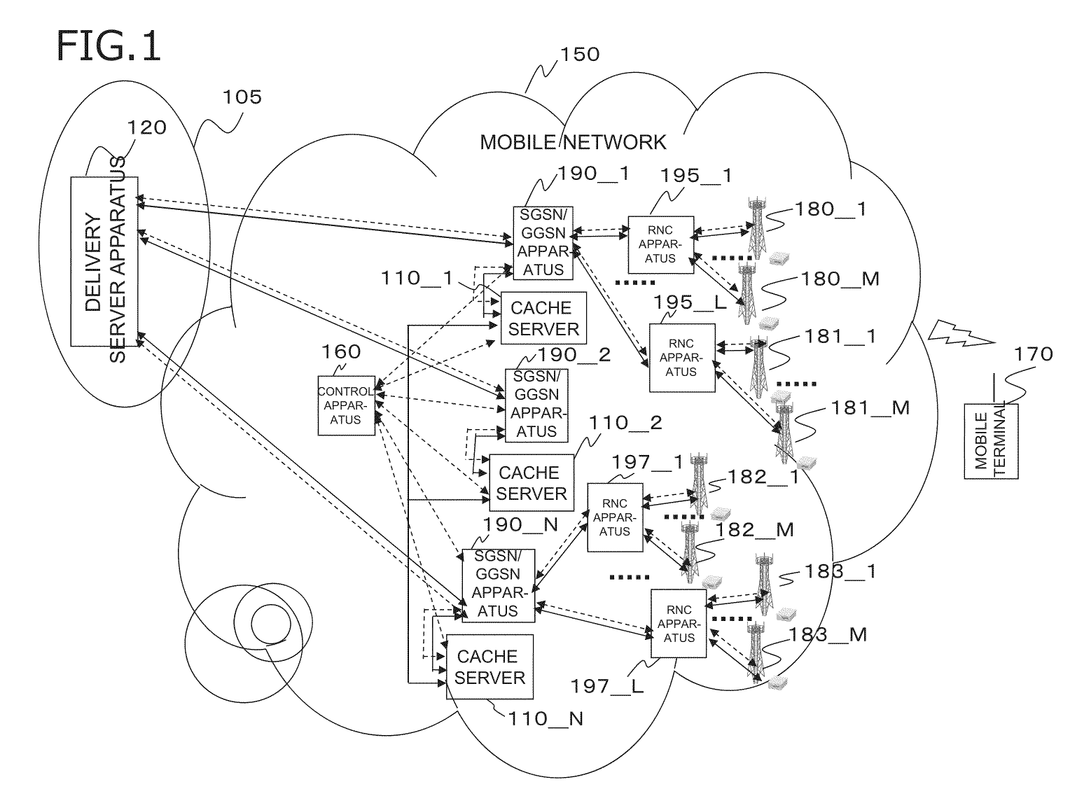

As illustrated in FIG. 1, a content delivery system according to the present invention includes: a packet forwarding apparatus(es) (SGSN/GGSN (Serving GPRS Support Node/Gateway GPRS Support Node) apparatuses 190_1 to 190_N in FIG. 1) that forwards a plurality of contents delivered from a delivery server apparatus (120) on the Internet (105); a plurality of cache servers (110_1 to 110_N) that are arranged for or connected to the packet forwarding apparatus(es) and that temporarily store at least some of the plurality of contents; and a control apparatus (160) that collects an access frequency of each of the at least some of the contents from the plurality of cache servers (110_1 to 110_N), arranges contents whose access frequency is equal to or higher than a predetermined threshold in the plurality of cache servers (110_1 to 110_N) in accordance with a predetermined arrangement, and arranges the other contents in the plurality of cache servers (110_1 to 110_N) in accordance with access frequencies of the other contents.

It is preferable that the control apparatus (160) generate copies of each content whose access frequency is lower than the predetermined threshold, the number of copies being determined based on a corresponding access frequency, and arrange the copies in the plurality of cache servers (110_1 to 110_N). In addition, it is preferable that the control apparatus (160) arrange the contents whose access frequency is lower than the predetermined threshold in a cache server(s) whose load is equal to or less than a predetermined threshold among the plurality of cache servers (110_1 to 110_N). In addition, the control apparatus (160) may arrange the contents whose access frequency is equal to or higher than the predetermined threshold in all the plurality of cache servers (110_1 to 110_N).

When a content delivery request is made by a terminal (for example, the mobile terminal 170), the control apparatus (160) selects a cache server storing the content from the plurality of cache servers (110_1 to 110_N) and instructs the selected cache server to deliver the content. In addition, it is preferable that, when plural cache servers among the plurality of cache servers (110_1 to 110_N) store the content requested by a terminal (170), the control apparatus (160) select a cache server with minimum load from the plural cache servers and instruct the cache server to deliver the content. In addition, it is preferable that, when a content delivery request is made by a terminal (170) and none of the plurality of cache servers (110_1 to 110_N) stores the content, the control apparatus (160) instruct a cache server selected from the plurality of cache servers (110_1 to 110_N) to acquire the content from the delivery server apparatus (120) and to deliver the content.

In addition, as illustrated in FIG. 1, in the content delivery system according to the present invention, two or more cache servers (110_1 to 110_N) temporarily storing at least some of the contents delivered from the delivery server apparatus (120) on the Internet are connected to the packet forwarding apparatus(es) (for example, the SGSN/GGSN apparatus 190_1) on a mobile network (150). In addition, the content delivery system includes at least one control apparatus (160) for controlling the two or more cache servers (110_1 to 110_N). In view of coordination among the cache servers (110_1 to 110_N), the control apparatus (160) uses predetermined evaluation criteria and calculates arrangement in cache servers. The control apparatus (160) instructs cache servers to cache contents whose arrangement has been calculated, and in accordance with the instruction, the cache servers cache the contents. If a content is requested by a terminal (for example, the mobile terminal 170), a cache server ((for example, 110_1) reads the requested content in view of coordination among the cache servers and delivers the content to the terminal (170) via the packet forwarding apparatus(es) (for example, 190_1).

In the content delivery system according to the present invention, the control apparatus (160) refers to an access frequency of each of the contents accumulated in the cache servers (110_1 to 110_N) and arranges contents whose access frequency is high in a plurality of cache servers in accordance with a predetermined arrangement. The control apparatus (160) arranges the other contents in a plurality of cache servers on the basis of the respective access frequencies. Thus, with the content delivery system according to the present invention, for example, contents whose access frequency is relatively high can be distributed and arranged in many cache servers and contents whose access frequency is relatively low can be arranged in fewer cache servers on the basis of the respective access frequencies. According to the content delivery system, it is possible to avoid congestion on a mobile network even when contents are delivered via the mobile network and a certain content is accessed in a concentrated manner.

According to the present invention, the following modes are possible.

### (Mode 1)

See the content delivery system according to the above first aspect.

### (Mode 2)

The control apparatus may generate copies of each content whose access frequency is lower than the predetermined threshold, the number of copies being determined based on a corresponding access frequency, and arrange the copies in the plurality of cache servers.

### (Mode 3)

The control apparatus may arrange the contents whose access frequency is lower than the predetermined threshold in a cache server(s) whose load is equal to or less than a predetermined threshold among the plurality of cache servers.

### (Mode 4)

The control apparatus may arrange the contents whose access frequency is equal to or higher than the predetermined threshold in all the plurality of cache servers.

### (Mode 5)

When a content delivery request is made by a terminal, the control apparatus may select a cache server storing the content from the plurality of cache servers and instruct the selected cache server to deliver the content.

### (Mode 6)

When plural cache servers among the plurality of cache servers store the content requested by the terminal, the control apparatus may select a cache server with minimum load from the plural cache servers and instruct the cache server to deliver the content.

### (Mode 7)

When a content delivery request is made by a terminal and none of the plurality of cache servers stores the content, the control apparatus may instruct a cache server selected from the plurality of cache servers to acquire the content from the delivery server apparatus and to deliver the content.

### (Mode 8)

When a content delivery request is made by a terminal, the control apparatus may instruct a cache server that is not storing the content among the plurality of cache servers to acquire the content from a cache server storing the content among the plurality of cache servers and to deliver the content.

### (Mode 9)

The packet forwarding apparatus(es) may be an SGSN apparatus, a GGSN apparatus, or an SGSN/GGSN apparatus on a mobile network or an S-GW (Serving Gateway) apparatus, a P-GW (Packet data network Gateway) apparatus, or an S/P-GW apparatus on a mobile LTE (Long Term Evolution)/EPC (Evolved Packet Core) network.

### (Mode 10)

The plurality of contents may include at least one of a moving image, a still image, voice, audio, software, an application, and data.

### (Mode 11)

See the control apparatus according to the above second aspect.

### (Mode 12)

The control apparatus may generate copies of each content whose access frequency is lower than the predetermined threshold, the number of copies being determined based on a corresponding access frequency, and arrange the copies in the plurality of cache servers.

### (Mode 13)

The control apparatus may arrange the contents whose access frequency is lower than the predetermined threshold in a cache server(s) whose load is equal to or less than a predetermined threshold among the plurality of cache servers.

### (Mode 14)

The control apparatus may arrange the contents whose access frequency is equal to or higher than the predetermined threshold in all the plurality of cache servers.

### (Mode 15)

When a content delivery request is made by a terminal, the control apparatus may select a cache server storing the content from the plurality of cache servers and instruct the selected cache server to deliver the content.

### (Mode 16)

When plural cache servers among the plurality of cache servers store the content requested by the terminal, the control apparatus may select a cache server with minimum load from the plural cache servers and instruct the cache server to deliver the content.

### (Mode 17)

When a content delivery request is made by a terminal and none of the plurality of cache servers stores the content, the control apparatus may instruct a cache server selected from the plurality of cache servers to acquire the content from the delivery server and to deliver the content.

### (Mode 18)

When a content delivery request is made by a terminal, the control apparatus may instruct a cache server that is not storing the content among the plurality of cache servers to acquire the content from a cache server storing the content among the plurality of cache servers and to deliver the content.

### (Mode 19)

See the content delivery method according to the above third aspect.

### (Mode 20)

There is provided a program, which is used in a content delivery system including a packet forwarding apparatus(es) that forwards a plurality of contents delivered from a delivery server apparatus on the Internet and a plurality of cache servers that are arranged for or connected to the packet forwarding apparatus(es) and that temporarily store at least some of the plurality of contents and which causes a computer provided for a control apparatus controlling the plurality of cache servers to execute: collecting an access frequency of each of the at least some of the contents from the plurality of cache servers;

arranging contents whose access frequency is equal to or higher than a predetermined threshold in the plurality of cache servers in accordance with a predetermined arrangement; and
arranging the other contents in the plurality of cache servers in accordance with access frequencies of the other contents.
The program can be provided as a program product recorded in a non-transient computer-readable recording medium.

Next, configurations and operations of content delivery systems according to exemplary embodiments will be described in detail with reference to FIGS. 1 to 5. As an example, each of the following exemplary embodiments will be described assuming that contents are moving images. However, the same configuration can be used even when the contents are still images, audio, voice, software, applications, data, and the like.

### First Exemplary Embodiment

A content delivery system according to a first exemplary embodiment will be described with reference to the drawings. FIG. 1 illustrates a connection configuration of the content delivery system according to the present exemplary embodiment. As illustrated in FIG. 1, the content delivery system includes: a delivery server apparatus 120 on the Internet 105; and SGSN/GGSN apparatuses 190_1 to 190_N, cache servers 110_1 to 110_N, a control apparatus 160, RNC (Radio Network Controller) apparatuses 195_1 to 195_L and 197_1 to 197_L, and base station apparatuses 180_1 to 180_M, 181_1 to 181_M, 182_1 to 182_M, and 183_1 to 183_M on a mobile network 150.

FIG. 1 illustrates a configuration in which a 3G (3rd Generation) mobile packet network is used as the mobile network and the SGSN/GGSN apparatuses are used as packet forwarding apparatuses. An SGSN/GGSN apparatus is an apparatus in which an SGSN (Serving GPRS Support Node) and a GGSN (Gateway GPRS Support Node) are co-located (arranged in a single station).

In FIG. 1, the delivery server apparatus 120 on the Internet 105 delivers Internet contents. Hereinafter, these Internet contents will be referred to as OTT (Over The Top) contents. In the present exemplary embodiment, an OTT content is a compressed-and-encoded bit stream of a content including at least one of a moving image, a still image, a web page, audio, voice, etc. or a file storing such compressed-and-encoded bit stream. The content may be software, an application, data, or the like while such case will not be described in the present exemplary embodiment.

The SGSN/GGSN apparatuses 190_1 to 190_N (N≧2) are arranged on the mobile network 150. The RNC apparatuses 195_1 to 195_L (L≧2) are connected to the SGSN/GGSN apparatus 190_1. Likewise, the RNC apparatuses 197_1 to 197_L are connected to the SGSN/GGSN apparatus 190_N. While the L RNC apparatuses are also connected to the SGSN/GGSN apparatus 190_2, illustration thereof is omitted in FIG. 1 due to limitations of the space. In addition, the M base stations (M≧2) are connected to each of the RNC apparatuses. For example, the M base station apparatuses 180_1 to 180_M are connected to the RNC apparatus 195_1.

In FIG. 1, a single cache server is connected to a GGSN function unit of each SGSN/GGSN apparatus. For example, the cache server 110_1 is connected to the SGSN/GGSN apparatus 190_1. The N cache servers 110_1 to 110_N (N≧2) are connected to the control apparatus 160. In addition, the cache servers 110_1 to 110_N are connected to each other so that these cache servers operate in coordination with each other.

The mobile terminal 170 transmits a delivery connection request message including the URL (Uniform Resource Locator) of a requested content. Next, a base station apparatus (in FIG. 1, one of the base station apparatuses 181_1 to 181_M) whose service area is being visited by the mobile terminal 170 receives the connection request message and transmits the connection request message to an RNC apparatus (in FIG. 1, the RNC apparatus 195_L) managing the base station apparatus.

The RNC apparatus 195_L receives the connection request message from the base station apparatus stores the connection request message, the IP (Internet Protocol) address of the delivery server apparatus 120, the IP address of the mobile terminal 170, and the like in a payload portion of a GTP (GPRS Tunneling Protocol) packet, and forwards the GTP packet to the SGSN/GGSN apparatus 190_1 managing the RNC apparatuses 195_1 to 195_L.

Next, the SGSN/GGSN apparatus 190_1 receives the GTP packet.

The cache server 110_1 is connected to a Gi interface of a GGSN function unit of the SGSN/GGSN apparatus 190_1. Likewise, the cache server 110_N is connected to a Gi interface of a GGSN function unit of the SGSN/GGSN apparatus 190_N.

The cache servers 110_1 to 110_N are connected to the control apparatus 160. The control apparatus 160 instructs two or more cache servers to arrange contents whose access frequency is higher than a threshold Th1 in a predetermined arrangement. In contrast, for some or all of the contents whose access frequency is lower than the threshold Th1, the control apparatus 160 calculates an optimum arrangement in the cache servers 110_1 to 110_N and transmits content arrangement instructions to the cache servers based on the calculation result.

If a cache server receives a content arrangement instruction from the control apparatus 160, the cache server accesses the specified content in the delivery server apparatus 120 via the corresponding SGSN/GGSN apparatus and accumulates the content in the cache server. In addition, when requested by the mobile terminal 170, the cache server delivers the requested content to the mobile terminal 170.

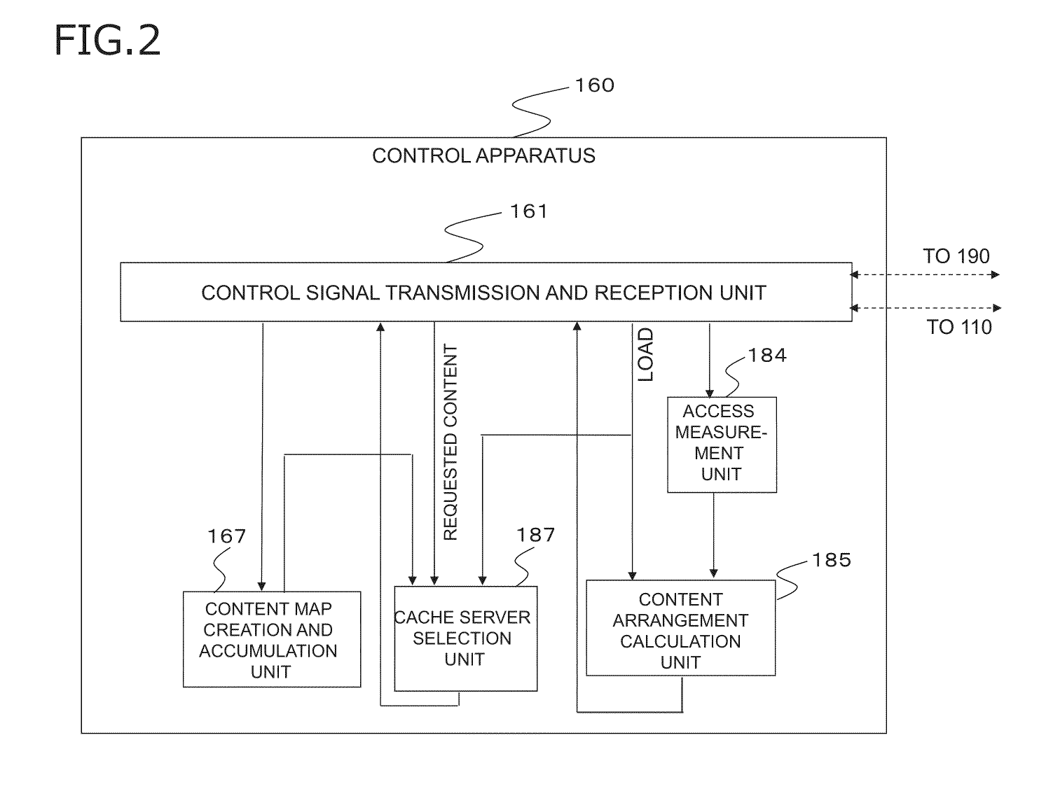

Next, a configuration of the control apparatus 160 will be described with reference to the drawings. FIG. 2 is a block diagram illustrating a configuration of the control apparatus 160. As illustrated in FIG. 2, the control apparatus 160 includes a control signal transmission and reception unit 161, an access measurement unit 184, a content arrangement calculation unit 185, a cache server selection unit 187, and a content map creation and accumulation unit 167.

The control signal transmission and reception unit 161 receives access frequency information about each content from each of the cache servers 110_1 to 110_N. In addition, the control signal transmission and reception unit 161 receives load information from each cache server. The control signal transmission and reception unit 161 outputs the access frequency information to the access measurement unit 184 and outputs the load information to the content arrangement calculation unit 185 and the cache server selection unit 187.

The access measurement unit 184 collects access number information about each content from each cache server at predetermined time intervals or when a predetermined condition is satisfied. The access measurement unit 184 adds up and sorts these items of access number information by the number of cache servers, to aggregate an access frequency per content for all of the cache servers. In addition, the access measurement unit 184 outputs such access frequency per content to the content arrangement calculation unit 185.

The content arrangement calculation unit 185 receives the load information about each cache server from the control signal transmission and reception unit 161 and receives the access frequency per content from the access measurement unit 184.

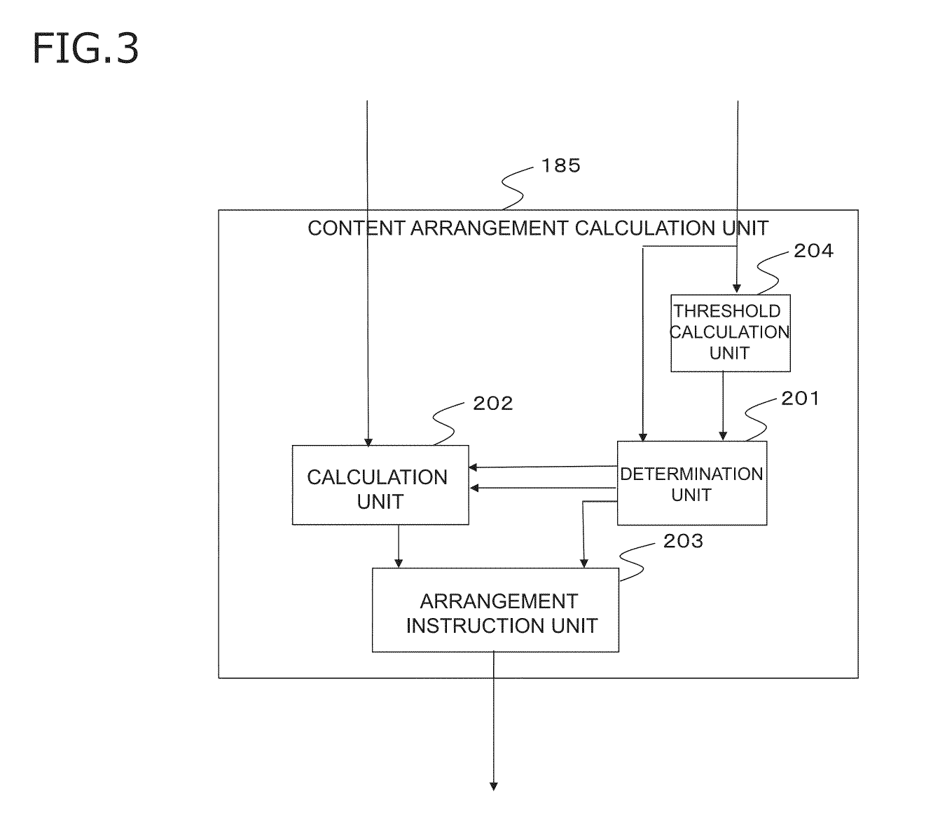

A configuration of the content arrangement calculation unit 185 will be described with reference to the drawings. FIG. 3 is a block diagram illustrating a configuration of the content arrangement calculation unit 185. As illustrated in FIG. 3, the content arrangement calculation unit 185 includes a threshold calculation unit 204, a determination unit 201, an arrangement instruction unit 203, and a calculation unit 202.

The threshold calculation unit 204 receives the access frequency per content from the access measurement unit 184 at predetermined time intervals or when a request is made and calculates the threshold Th1 for an access frequency. For example, the threshold calculation unit 204 may calculate an average access frequency and an access distribution of a content and set a threshold to the top Y %. The threshold calculation unit 204 outputs the threshold Th1 to the determination unit 201.

The determination unit 201 receives an access frequency per content from the access measurement unit 184 at predetermined time intervals or when a request is made. The determination unit 201 also receives the threshold Th1 from the threshold calculation unit 204. The determination unit 201 determines contents whose access frequency exceeds the threshold Th1 and outputs information about the contents to the arrangement instruction unit 203.

For the contents whose access frequency exceeds the threshold Th1, the arrangement instruction unit 203 gives an instruction about a predetermined arrangement. As to the predetermined arrangement, the arrangement instruction unit 203 may give an instruction so that the contents whose access frequency exceeds the predetermined threshold Th1 are arranged in all the cache servers 110_1 to 110_N. However, the arrangement method is not limited to such method.

In addition, the determination unit 201 outputs information about the contents whose access frequency is lower than the predetermined threshold Th1 and access frequency information about each of the contents to the calculation unit 202.

The calculation unit 202 receives the information about the contents whose access frequency is lower than the predetermined threshold Th1 and the access frequency information about each of the contents from the determination unit 201. In addition, the calculation unit 202 receives load information about each cache server from the control signal transmission and reception unit 161. The calculation unit 202 determines which cache servers need to accumulate necessary contents, for example, in view of coordination among the cache servers as will be described below.

The calculation unit 202 sorts the contents in descending order of access frequency and creates Kj copies of each of the contents in descending order of access frequency (0≦Kj≦M). j represents a content number, and M is an integer that satisfies 0<M≦N. In addition, N is the number of cache servers.

The calculation unit 202 may vary this value Kj, depending on the content. For example, more copies are created for contents whose access frequency is higher and fewer copies are created for contents whose access frequency is lower. For example, the calculation unit 202 may set M as Kj for a content with a high access frequency and set smaller values M−1, M−2, and so on for the other contents with lower access frequencies, sequentially. Alternatively, the calculation unit 202 may set Kj=1 for a content with a low access frequency and Kj=0 when a content exceeds the capacity of a cache.

It is preferable that the calculation unit 202 arrange the Kj copies of a content in Kj cache servers, respectively. In addition, it is preferable that, as the Kj cache servers, the calculation unit 202 select cache servers in descending order of access frequency of the content in question. Alternatively, the calculation unit 202 may randomly select the Kj cache servers.

When determining arrangement of contents in a cache server, the calculation unit 202 uses formula (1) to calculate the total size of the contents that can be accumulated in the cache server. If the total size exceeds the capacity of the cache server, the calculation unit 202 does not arrange any more contents.

$$Si = {\sum }_{k} Sik \qquad ( 1 )$$

In formula (1), Si represents the total size (in bytes) of an i-th cache server and Sik represents the size (in bytes) of a k-th content arranged in the i-th cache server.

In order to reduce throughput of the calculation unit 202 for determining arrangement of the contents, the following configurations may be used. First, the calculation unit 202 may arrange contents only in a plurality of predetermined cache servers. Second, the calculation unit 202 may arrange contents only in cache servers satisfying a predetermined condition. For example, the calculation unit 202 arranges contents only in cache servers that have transmitted load information indicating a load value equal to or lower than a predetermined threshold. Third, from the contents whose access frequency is less than the threshold Th1, the calculation unit 202 may extract only predetermined P contents in descending order of access frequency and arrange the extracted P contents.

After receiving an output from the calculation unit 202, the arrangement instruction unit 203 instructs each cache server, which has been determined as an arrangement target by the calculation unit 202, to acquire and accumulate a copy(ies) of an arrangement target content via the control signal transmission and reception unit 161 in FIG. 2.

The arrangement instruction unit 203 may instruct the target cache server(s) to acquire a copy(ies) of the arrangement target content from the delivery server apparatus 120. Alternatively, if a certain cache server does not have a content and if a neighboring cache server has the content, the arrangement instruction unit 203 may instructs the certain cache server to acquire a copy(ies) of the content from the neighboring cache server. In this case, information about which cache server has the necessary content is read from the content map creation and accumulation unit 167 in FIG. 2, and the read information is inputted to the arrangement instruction unit 203 in FIG. 3.

In addition, for contents that have not been determined by the calculation unit 202 as arrangement calculation targets, the arrangement instruction unit 203 may instruct the cache servers to perform the following processing. Namely, when receiving a request for a content from the mobile terminal 170, the arrangement instruction unit 203 may instruct a cache server to read the content from the delivery server apparatus 120, instruct the temporary content accumulation unit 113 of a cache server to cache the content, and instruct the cache server to deliver the content to the mobile terminal 170. Alternatively, when receiving a request from the mobile terminal 170, the arrangement instruction unit 203 may instruct a cache server to read the content from the delivery server apparatus 120 and to deliver the content to the mobile terminal 170 without instructing the temporary content accumulation unit 113 of the cache server to cache the content.

Next, the control apparatus 160 in FIG. 2 will be further described. The cache server selection unit 187 receives information about a content (for example, the URL of a content) requested by the mobile terminal 170 from the control signal transmission and reception unit 161. In addition, the cache server selection unit 187 receives a content map from the map creation and accumulation unit 167. The content map indicates which contents are cached in each cache server. The cache server selection unit 187 selects cache servers in accordance with the following procedure. As a first procedure, the cache server selection unit 187 determines a group of cache servers in which the content requested by the mobile terminal 170 is cached and selects an appropriate cache server(s) from the cache servers.

Alternatively, the following procedure may be added to the first procedure. Namely, as a second procedure, the cache server selection unit 187 uses load information about the group of cache servers selected in the first procedure, determines cache servers with load equal to or less than a predetermined threshold, and selects a cache server with minimum load.

Next, the cache server selection unit 187 instructs the cache server selected in accordance with the above procedure to deliver the content requested by the mobile terminal 170 via the control signal transmission and reception unit 161. If the content map of the content map creation and accumulation unit 167 indicates that the requested content is not cached in any one of the cache servers, which could be the case with contents with an extremely low access frequency, the cache server selection unit 187 instructs a cache server to acquire the content from the delivery server apparatus 120.

The content map creation and accumulation unit 167 receives a content list from each of the cache servers 110_1 to 110_N via the control signal transmission and reception unit 161, for example, at predetermined time intervals and creates and accumulates a content map indicating what contents are temporarily accumulated in which cache servers. In addition, the content map creation and accumulation unit 167 outputs the content map to the cache server selection unit 187 at predetermined time intervals or upon request.

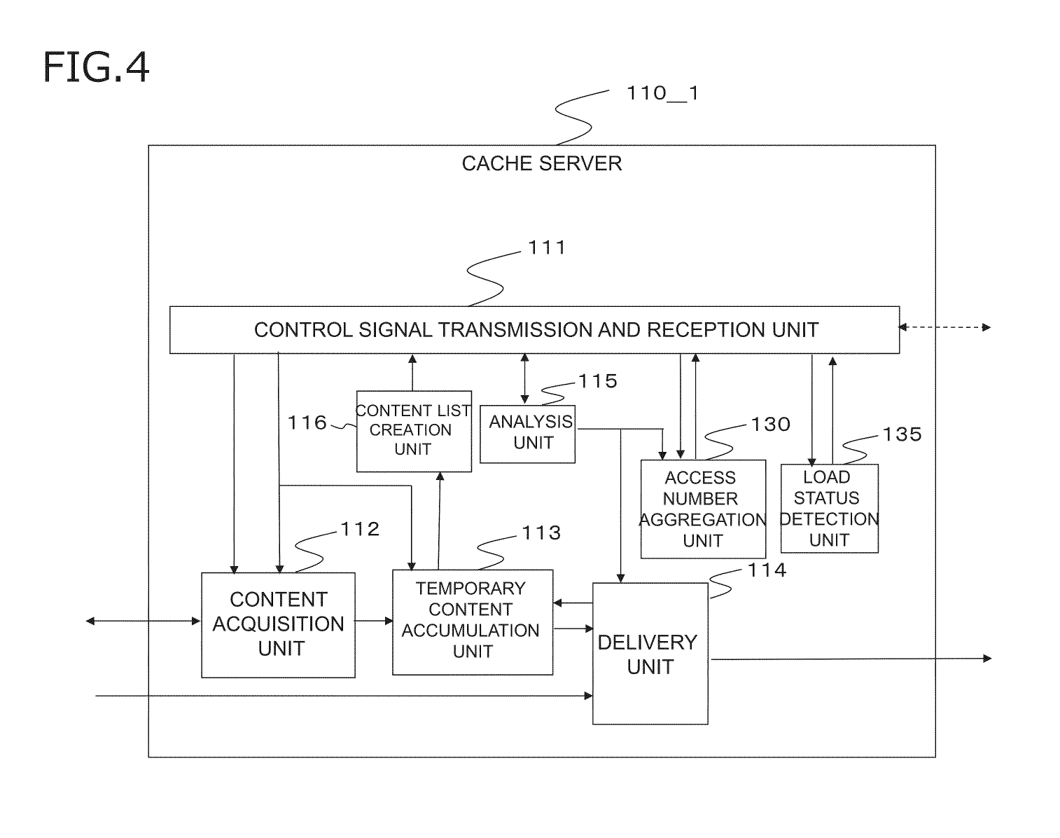

Next, a configuration of the cache server 110_1 connected to the SGSN/GGSN apparatus 190_1 will be described with reference to the drawings. FIG. 4 is a block diagram illustrating a configuration of the cache server 110_1. Since the cache servers 110_2 to 110_N have the same configuration as that of the cache server 110_1, description thereof will be omitted. As illustrated in FIG. 4, the cache server 110_1 includes a control signal transmission and reception unit 111, an analysis unit 115, a content acquisition unit 112, a temporary content accumulation unit 113, a content list creation unit 116, an access number aggregation unit 130, a load status detection unit 135, and a delivery unit 114.

The control signal transmission and reception unit 111 receives a GTP packet storing a connection request message sent by the mobile terminal 170, the IP address of the mobile terminal 170, the URL of a requested content, and the like from the SGSN/GGSN apparatus 190_1.

The analysis unit 115 reads the connection request message stored in a payload portion of the GTP packet, extracts information about the IP address of the mobile terminal 170, the URL of the requested content, and the like, and transmits the extracted information to the control apparatus 160 via the control signal transmission and reception unit 111. In addition, the analysis unit 115 outputs the information about the URL of the content and the like to the access number aggregation unit 130.

The content acquisition unit 112 receives a content arrangement instruction transmitted from the arrangement instruction unit 203 illustrated in FIG. 3 via the control signal transmission and reception unit 111, receives a cache server selection instruction transmitted from the cache server selection unit 187 via the control signal transmission and reception unit 111, and acquires the content instructed to be arranged. If instructed to acquire the requested content from the delivery server apparatus 120 or another cache server, the content acquisition unit 112 reads the specified content from the delivery server apparatus 120 or another cache server and outputs the acquired content to the temporary content accumulation unit 113.

The temporary content accumulation unit 113 temporarily caches the content acquired and outputted by the content acquisition unit 112.

The content list creation unit 116 creates a content list of all the contents cached in the temporary content accumulation unit 113 of the cache server 110_1 at predetermined time intervals or when a predetermined condition is satisfied. In addition, the content list creation unit 116 transmits the content list of the cache server 110_1 to the control apparatus 160 via the control signal transmission and reception unit 111.

For each of the contents for which the cache server 110_1 receives a connection request, the access number aggregation unit 130 receives information about the URL of the requested content from the analysis unit 115. Based on the inputted information, the access number aggregation unit 130 calculates an access number per content by aggregating the number of connection requests from the mobile terminal 170 within a predetermined period of time. The access number aggregation unit 130 transmits an access number per content to the control apparatus 160 via the control signal transmission and reception unit 111.

The load status detection unit 135 measures a load status Q of the cache server 110_1 at predetermined time intervals or when a predetermined condition is satisfied and transmits the measured load status Q to the control apparatus 160 via the control signal transmission and reception unit 111. The load status detection unit 135 may measure the load status Q when the control apparatus 160 requests the cache server 110_1 to transmit the load status, which is an example of the predetermined condition. The load status detection unit 135 may measure the load status Q when a different condition is satisfied.

The load status detection unit 135 calculates the load status Q in accordance with formula (2).

$$Q = {\sum }_{j} Aj * Sj \qquad ( 2 )$$

In formula (2), Q is an index representing the load status of the cache server 110_1, j represents the number of a content temporarily accumulated in the cache server 110_1, Aj represents the number of requests made for a j-th content, and Sj represents the size of the j-th content. Alternatively, the load status detection unit 135 may calculate the load status by using a different formula other than formula (2).

The delivery unit 114 receives information about the URL of the requested content from the analysis unit 115. Based on this information, the delivery unit 114 searches the temporary content accumulation unit 113, reads the requested content, and generates a packet of a predetermined protocol. Next, the delivery unit 114 transmits the generated packet to the SGSN/GGSN apparatus 190_1 to deliver the packet to the mobile terminal 170 via the SGSN/GGSN apparatus 190_1. For example, a TCP protocol (Transmission Control Protocol) or an HTTP protocol (Hypertext Transfer Protocol) can be used as the predetermined protocol.

If the requested content is not cached in the temporary content accumulation unit 113 of a cache server and if the cache server selection unit 187 in FIG. 2 instructs the cache server to read the requested content from the delivery server apparatus 120 and to deliver the requested content, the delivery unit 114 reads the requested content from the delivery server apparatus 120, causes the temporary content accumulation unit 113 of the cache server 110_1 to cache the content, generates a packet of a predetermined protocol, and delivers the packet to the mobile terminal 170. Alternatively, after reading the content from the delivery server apparatus 120, the delivery unit 114 may deliver the content to the mobile terminal 170 without causing the temporary content accumulation unit 113 of the cache server 110_1 to cache the content.

If the requested content is not cached in the temporary content accumulation unit 113 of a cache server and if the cache server selection unit 187 in FIG. 2 instructs the cache server to read the requested content from another cache server through coordination among the cache servers and to deliver the requested content, the delivery unit 114 reads the requested content from a specified cache server, causes the temporary content accumulation unit 113 of the cache server 110_1 to cache the content, generates a packet of a predetermined protocol, and delivers the content to the mobile terminal 170.

Various variations can be made to the content delivery system according to the first exemplary embodiment described above.

FIG. 1 illustrates a configuration in which the cache servers are connected to the GGSN function units of the SGSN/GGSN apparatuses, respectively. However, alternatively, the cache servers may be connected to the SGSN function units, respectively. At least one of the cache servers and the control apparatus 160 may be incorporated in an SGSN/GGSN apparatus or co-located with an SGSN/GGSN apparatus.

The number of control apparatuses 160 is not limited to one. Two or more control apparatuses may be arranged, and these control apparatuses may share processing. Alternatively, the control apparatus 160 may be incorporated in at least one cache server.

A predetermined value may be set as the threshold Th1 in the control apparatus 160. The threshold Th1 may be set to 0 or ∞. If the threshold Th1 is set to ∞, since the access frequency does not exceed Th1, the content arrangement calculation unit 185 does not arrange any contents in accordance with a predetermined arrangement. In addition, there may be cases where the control apparatus 160 does not use load information about each cache server.

The content arrangement calculation unit 185 may perform content arrangement calculation and instruct target cache servers to cache target contents at predetermined time intervals or when a predetermined condition is satisfied. The content arrangement calculation unit 185 may perform the above operations when the access frequency of a content aggregated by the access measurement unit 184 has changed from the past access frequency and a degree of the change exceeds a predetermined threshold, which is an example of the predetermined condition. However, the content arrangement calculation unit 185 can use a different condition other than the above condition. Alternatively, the content arrangement calculation unit 185 may calculate arrangement of contents based on a different configuration.

The load status detection unit 135 may calculate the load status by using a different formula other than the formula (2).

In FIG. 1, the cache servers 110_1 to 110_N are connected to each other to achieve coordination among the cache servers so that contents can be transmitted and received among the cache servers. However, alternatively, the cache servers 110_1 to 110_N may be disconnected from each other so that the cache servers 110_1 to 110_N operate separately.

FIG. 1 illustrates a configuration in which a single cache server is connected to a single SGSN/GGSN apparatus. However, a single cache server may be connected to a plurality of SGSN/GGSN apparatuses. Alternatively, a plurality of cache servers may be connected to a single SGSN/GGSN apparatus.

In addition, the delivery server apparatus 120 and the cache server apparatuses 110_1 to 110_N may be connected to each other.

FIG. 1 illustrates a configuration using SGSN/GGSN apparatuses, and an SGSN apparatus and a GGSN apparatus are integrated in each of the SGSN/GGSN apparatuses. However, a configuration in which an SGSN apparatus and a GGSN apparatus are separated from each other may be used. In such case, at least one cache server is connected to either the SGSN apparatus or the GGSN apparatus.

In addition, the mobile terminal 170 may be a mobile phone, a smartphone, or a PC equipped with a data communication card. Alternatively, the mobile terminal 170 may be any terminal as long as the terminal can communicate with a mobile 3G network.

### Second Exemplary Embodiment

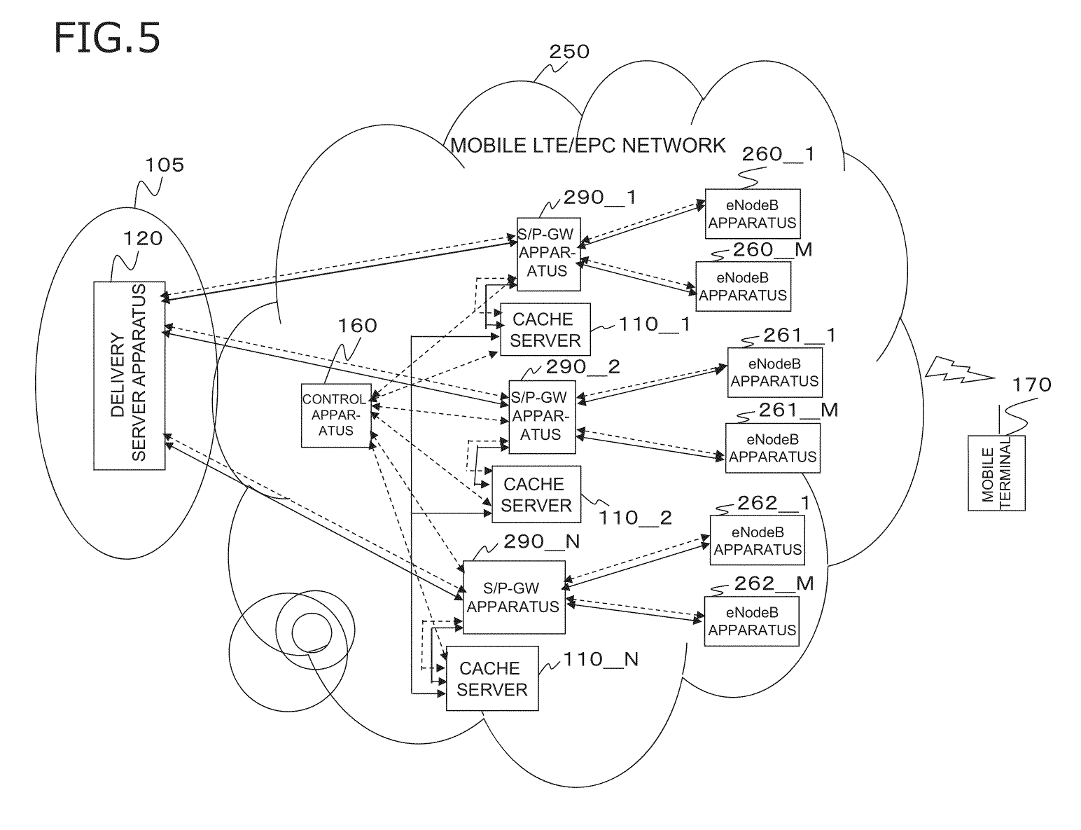

A content delivery system according to a second exemplary embodiment will be described with reference to the drawings. FIG. 5 illustrates a configuration of the content delivery system according to the present exemplary embodiment.

In FIG. 5, some components are denoted by the same reference characters as those in FIG. 1. Since these components perform the same operations as those in FIG. 1, description thereof will be omitted. In FIG. 5, in place of a 3G mobile network, an LTE (Long Term Evolution)/EPC (Evolved Packet Core) network, which is a 3.9G mobile network, is used as a mobile network 250. In LTE, while the functions of the base station apparatuses and the RNC apparatuses have been degenerated, eNodeB apparatuses are used, instead.

In addition, in EPC, S/P-GW (Serving/Packet Data-Gateway) apparatuses are connected to corresponding eNodeB apparatuses. An S/P-GW apparatus is an apparatus in which an S-GW apparatus and a P-GW apparatus are integrated. FIG. 5 illustrates a configuration in which M eNodeB apparatuses are connected to a single S/P-GW apparatus. For example, eNodeB apparatuses 260_1 to 260_M are connected to an S/P-GW apparatus 290_1.

In FIG. 5, a single cache server is connected to each S/P-GW apparatus. For example, the cache server 110_1 is connected to the S/P-GW apparatus 290_1.

The mobile terminal 170 transmits a connection request message including the IP address of the delivery server apparatus 120. Next, an eNodeB apparatus (in FIG. 5, one of the eNodeB apparatuses 261_1 to 261_M) whose service area is being visited by the mobile terminal 170 receives the connection request message. The one of the eNodeB apparatuses 261_1 to 261_M stores the connection request message, the IP address of the delivery server apparatus 120, the IP address of the mobile terminal 170, and the like in a payload portion with a GTP protocol and forwards the GTP packet to an S/P-GW apparatus 290_2.

The cache server 110_1 has the same configuration as that of the cache server 110_1 (FIG. 4) in the first exemplary embodiment. However, in the present exemplary embodiment, the control signal transmission and reception unit 111 is connected to the S/P-GW apparatus 290_1. Thus, the control signal transmission and reception unit 111 receives the GTP packet, which stores the connection request message, the IP address, and the like and location information about the mobile terminal 170 transmitted from the mobile terminal 170, from the S/P-GW apparatus 290_1. The other cache servers 110_2 to 110_N also perform this exchange with the respective S/P-GW apparatuses 290_2 to 290_N.

In addition, in the present exemplary embodiment, the delivery server apparatus 120 is connected to each of the S/P-GW apparatuses 290_1 to 290_N.

Various variations can be made to the content delivery system according to the above second exemplary embodiment. However, since the same variations as those described in the first exemplary embodiment can be made, detailed description thereof will be omitted.

FIG. 5 illustrates a configuration in which a single cache server is connected to a single S/P-GW apparatus. However, a single cache server may be connected to a plurality of S/P-GW apparatuses. Alternatively, a plurality of cache servers may be connected to a single S/P-GW apparatus.

In addition, FIG. 5 illustrates a configuration using S/P-GW apparatuses, and an S-GW apparatus and a P-GW apparatus are integrated in each of the S/P-GW apparatuses. However, a configuration in which an S-GW apparatus and a P-GW apparatus are separated from each other may be used. In such case, at least one cache server is connected to either the S-GW apparatus or the P-GW apparatus.

For example, the following advantageous effects are provided by the content delivery systems according to the above first and second exemplary embodiments.

The control apparatus 160 arranges contents whose access frequency is higher than a threshold in two or more cache servers in a predetermined arrangement. For some of the contents whose access frequency is lower than a threshold, the control apparatus 160 uses access frequency information or the like to calculate arrangement of each of the contents in cache servers. In addition, the control apparatus 160 instructs the cache servers to cache the contents that are instructed to be arranged. After caching the contents temporarily, the cache servers deliver the contents.

In this way, even when there is a content with high popularity, concentration of load on the mobile network and concentration of accesses to the delivery server apparatus 120 can be avoided. Therefore, congestion on the mobile network can be avoided. These effects are more significant if more terminals are used or larger-capacity contents are delivered. There are other advantageous effects for users. Namely, since problems such as delay and packet loss are not caused, freeze-up of an image or interruption of voice on the terminal side is not caused.

In addition, for example, even when a new content is introduced and popularity of a certain content is rapidly changed, concentration of the traffic to the delivery server apparatus or of the traffic on a network can be avoided. Thus, congestion can be avoided, counted as an advantageous effect.

In addition, according to the content delivery systems, the above advantageous effects can be provided without making any modification to the terminal.

The disclosure of prior art including the above PTL is incorporated herein by reference thereto. Modifications and adjustments of the exemplary embodiments are possible within the scope of the overall disclosure (including the claims) of the present invention and based on the basic technical concept of the present invention. Various combinations and selections of various disclosed elements (including each element in each claim, example, drawing, etc.) are possible within the scope of the claims of the present invention. That is, the present invention of course includes various variations and modifications that could be made by those skilled in the art according to the overall disclosure including the claims and the technical concept. The description discloses numerical value ranges. However, even if the description does not particularly disclose arbitrary numerical values or small ranges included in the ranges, these values and ranges should be deemed to have been specifically disclosed.
105 Internet
110_1 to 110_N cache server
111 control signal transmission and reception unit
112 content acquisition unit
113 temporary content accumulation unit
114 delivery unit
115 analysis unit
116 content list creation unit
120 delivery server apparatus
130 access number aggregation unit
135 load status detection unit
150 mobile network
160 control apparatus
161 control signal transmission and reception unit
167 content map creation and accumulation unit
170 mobile terminal
   180_1 to 180_M, 181_1 to 181_M, 182_1 to 182_M, 183_1 to 183_M base station apparatus
184 access measurement unit
185 content arrangement calculation unit
187 cache server selection unit
190_1 to 190_N SGSN/GGSN apparatus
195_1 to 195_L, 197_1 to 197_L RNC apparatus
201 determination unit
   202 calculation unit
203 arrangement instruction unit
204 threshold calculation unit
250 mobile LTE/EPC network
260_1 to 260_M, 261_1 to 261_M, 262_1 to 262_M eNodeB apparatus
290_1 to 290_N S/P-GW apparatus
Th1 threshold

What is claimed is:

1. A content delivery system, comprising:
a packet forwarding apparatus(es) that forwards a plurality of contents delivered from a delivery server apparatus on the Internet;
a plurality of cache servers that are arranged for or connected to the packet forwarding apparatus(es) and that temporarily store at least some of the plurality of contents; and
a control apparatus that collects an access frequency of each of the at least some of the contents from the plurality of cache servers, arranges contents whose access frequency is equal to or higher than a predetermined threshold in the plurality of cache servers in accordance with a predetermined arrangement, and arranges the other contents in the plurality of cache servers in accordance with access frequencies of the other contents.

2. The content delivery system according to claim 1;
wherein the control apparatus generates copies of each content whose access frequency is lower than the predetermined threshold, the number of copies being determined based on a corresponding access frequency, and arranges the copies in the plurality of cache servers.

3. The content delivery system according to claim 1;
wherein the control apparatus arranges the contents whose access frequency is lower than the predetermined threshold in a cache server(s) whose load is equal to or less than a predetermined threshold among the plurality of cache servers.

4. The content delivery system according to claim 1;
wherein the control apparatus arranges the contents whose access frequency is equal to or higher than the predetermined threshold in all the plurality of cache servers.

5. The content delivery system according to claim 1;
wherein, when a content delivery request is made by a terminal, the control apparatus selects a cache server storing the content from the plurality of cache servers and instructs the selected cache server to deliver the content.

6. The content delivery system according to claim 5;
wherein, when plural cache servers among the plurality of cache servers store the content requested by the terminal, the control apparatus selects a cache server with minimum load from the plural cache servers.

7. The content delivery system according to claim 1;
wherein, when a content delivery request is made by a terminal and none of the plurality of cache servers stores the content, the control apparatus instructs a cache server selected from the plurality of cache servers to acquire the content from the delivery server apparatus and to deliver the content.

8. The content delivery system according to claim 1;
wherein, when a content delivery request is made by a terminal, the control apparatus instructs a cache server that is not storing the content among the plurality of cache servers to acquire the content from a cache server storing the content among the plurality of cache servers and to deliver the content.

9. The content delivery system according to claim 1;
wherein the packet forwarding apparatus(es) is an SGSN (Serving GPRS Support Node) apparatus, a GGSN (Gateway GPRS Support Node) apparatus, or an SGSN/GGSN apparatus on a mobile network or an S-GW apparatus, a P-GW apparatus, or an S/P-GW apparatus on a mobile LTE (Long Term Evolution)/EPC (Evolved Packet Core) network.

10. The content delivery system according to claim 1;
wherein the plurality of contents include at least one of a moving image, a still image, voice, audio, software, an application, and data.

11. A control apparatus, which is used in a content delivery system including a packet forwarding apparatus(es) that forwards a plurality of contents delivered from a delivery server apparatus on the Internet and a plurality of cache servers that are arranged for or connected to the packet forwarding apparatus(es) and that temporarily store at least some of the plurality of contents and which controls the plurality of cache servers;
wherein the control apparatus collects an access frequency of each of the at least some of the contents from the plurality of cache servers, arranges contents whose access frequency is equal to or higher than a predetermined threshold in the plurality of cache servers in accordance with a predetermined arrangement, and arranges the other contents in the plurality of cache servers in accordance with access frequencies of the other contents.

12. The control apparatus according to claim 11;
wherein the control apparatus generates copies of each content whose access frequency is lower than the predetermined threshold, the number of copies being determined based on a corresponding access frequency, and arranges the copies in the plurality of cache servers.

13. The control apparatus according to claim 11;
wherein the control apparatus arranges the contents whose access frequency is lower than the predetermined threshold in a cache server(s) whose load is equal to or less than a predetermined threshold among the plurality of cache servers.

14. The control apparatus according to claim 11;
wherein the control apparatus arranges the contents whose access frequency is equal to or higher than the predetermined threshold in all the plurality of cache servers.

15. The control apparatus according to claim 11;
wherein, when a content delivery request is made by a terminal, the control apparatus selects a cache server storing the content from the plurality of cache servers and instructs the selected cache server to deliver the content.

16. The control apparatus according to claim 15;
wherein, when plural cache servers among the plurality of cache servers store the content requested by the terminal, the control apparatus selects a cache server with minimum load from the plural cache servers and instructs the cache server to deliver the content.

17. The control apparatus according to claim 11;
wherein, when a content delivery request is made by a terminal and none of the plurality of cache servers stores the content, the control apparatus instructs a cache server selected from the plurality of cache servers to acquire the content from the delivery server and to deliver the content.

18. The control apparatus according to claim 11;
wherein, when a content delivery request is made by a terminal, the control apparatus instructs a cache server that is not storing the content among the plurality of cache servers to acquire the content from a cache server storing the content among the plurality of cache servers and to deliver the content.

19. A content delivery method, which is used in a content delivery system including a packet forwarding apparatus(es) that forwards a plurality of contents delivered from a delivery server apparatus on the Internet and a plurality of cache servers that are arranged for or connected to the packet forwarding apparatus(es) and that temporarily store at least some of the plurality of contents, the content delivery method comprising:
by a control apparatus controlling the plurality of cache servers, collecting an access frequency of each of the at least some of the contents from the plurality of cache servers;
arranging contents whose access frequency is equal to or higher than a predetermined threshold in the plurality of cache servers in accordance with a predetermined arrangement; and
arranging the other contents in the plurality of cache servers in accordance with access frequencies of the other contents.

20. The content delivery method according to claim 19, comprising:
by the control apparatus, generating copies of each content whose access frequency is lower than the predetermined threshold, the number of copies being determined based on a corresponding access frequency, and arranging the copies in the plurality of cache servers.
